(19) United States
(12) Patent Application Publication
(10) Pub. No.: US 2002/0059408 A1
(43) Pub. Date: May 16, 2002

(54) Dynamic traffic management on a shared medium

(76) Inventors: Krishna Pattabhiraman, Westborough, MA (US); Yahia El Kachab, Cambridge, MA (US); Surya Kumar Kovvali, Westborough, MA (US); Ramji Raghavan, Waltham, MA (US); Charles W. Boyle, Shrewsbury, MA (US)

Correspondence Address: FRANK R. OCCHIUTI, Fish & Richardson P.C., 225 Franklin Street, Boston, MA, 02110-2804, US

(21) Appl. No.: 09/907,529

(22) Filed: Jul. 17, 2001

Related U.S. Application Data
(60) Provisional application No. 60/245,387, filed on Nov. 2, 2000.
(60) Provisional application No. 60/245,262, filed on Nov. 2, 2000.

(51) Int. Cl. G06F 15/173

(52) U.S. Cl. 709/223

(57) ABSTRACT

An approach for managing dynamic traffic on a shared medium, for example, on a SONET ring, makes use of a central arbiter that communicates with stations coupled to the medium. Each station makes requests to change bandwidth for dynamic traffic entering the medium at that station, and also implements a congestion avoidance algorithm that is coordinated with its requests for changes in bandwidth. The central arbiter responds to the requests from the stations to provide a fair allocation of bandwidth available on the shared medium.

### CROSS REFERENCE TO RELATED APPLICATIONS

This application claims the benefit of U.S. Provisional Application Nos. 60/245,387 and 60/245,262, both filed on Nov. 2, 2000, both of which are incorporated herein by reference. This application is also related to U.S. application Ser. No. 09/536,416, “Transport of Isochronous and Bursty Data on a SONET Ring,” filed on Mar. 28, 2000, and to U.S. application Ser. No. 09/858,019, “Scalable Transport of TDM Channels in a Synchronous Frame,” filed May 15, 2001, which are also incorporated herein by reference.

### BACKGROUND

This invention relates to management of dynamic traffic on a shared medium.

Various network architectures are used to communicate data. Possibly the most popular is Ethernet. Ethernet is a bus technology that uses the carrier sense medium access with collision detection (CSMA/CD) MAC protocol. Each station connected to the bus senses the medium before starting a packet transmission. If a collision is detected during transmission, the transmitting station immediately ceases transmission and transmits a brief jamming signal to indicate to all stations that there has been a collision. It then waits for a random amount of time before attempting to transmit again using CSMA.

There is no explicit bandwidth management on the Ethernet bus. Each station independently takes decision to transmit and may perform local traffic management across the flows originating at this station. Thus, this scheme does not necessarily provide for efficient traffic management across all the flows sharing the bus.

Another architecture uses a token bus. The medium access protocol of token bus is similar to IEEE 802.5 Token ring, which is described below.

DQDB (Distributed Queue Double Bus) is a technology accepted by IEEE in standard IEEE 802.6 for Metropolitan Area Networks (MAN). DQDB uses dual buses, with stations attached to both buses. A frame generator is at the end of each bus, creating frames of empty slots. The stations can read from either bus, and can ‘OR’ in data to either bus. DQDB medium access (queue arbitration) mechanism provides an access method as follows:

each slot has a Busy (B) bit and a Request (R) bit

when a station wants to place data on one bus, it sets the R bit on a passing slot on the other bus. (This is to alert upstream stations that a request has been made.)

each station keeps a Request Counter (RC) which is incremented by 1 each time a slot passes with the R bit set and is decremented by 1 each time an empty slot passes on the other bus

when the RC reaches 0, the station can use the next empty (B not set) slot on the other bus.

This access mechanism can be unfair, however. Stations near an end of the bus are mainly limited to one bus capacity. Stations near the center have more access to the two buses and thus have more capacity available to them, and on average have shorter transmission paths. Stations near the head of a bus tend to get better access to empty slots

Another architecture uses the IEEE 802.5 Token Ring standard. Each token ring network, which is a 4 or 16 Mb/s ring, is shared by each station attached to the ring. Stations access the token ring by getting permission to send data. Permission is granted when a station receives a special message called a “token”. The transmitting station captures the token, changes it into a “frame”, embeds the data into the frame's information field, and transmits it. Other stations receive the data if the frame is addressed to them. All stations, including those receiving the data, rebroadcast the frame so that it returns to the originating station. The station strips the data from the ring and issues a new token for use by the next downstream station with data to transmit. In addition, token ring has eight levels of priority available for prioritized transmissions. When a station has urgent information to send, it makes a high-priority reservation. When the token is made available with a reservation request outstanding, it becomes a “priority token”. Only stations with priority requests can use the token. Other stations will wait till a normal (non-priority) token becomes available.

The Fiber Distributed Data Interface (FDDI) is a standard for a high-speed ring network. Like the IEEE 802.5 standard, FDDI employs the token ring algorithm. However, the FDDI token management scheme is more efficient especially for large rings, thus providing higher ring utilizations. Another difference between FDDI and IEEE token ring is in the area of capacity allocation. FDDI provides support for a mixture of stream and bursty traffic. It defines two types of traffic: synchronous and asynchronous. The synchronous portion of each station is guaranteed by the protocol. Each station uses the bandwidth remaining beyond the synchronous portion for transmitting asynchronous traffic. However, there is no inbuilt mechanism to allocate the asynchronous portion in a fair manner across the stations. Even though each node is given opportunity to transmit asynchronous traffic, the distribution across the ring of “transmit” opportunity for asynchronous traffic is not necessarily done in a fair manner. This is in part because each node independently decides to send the asynchronous portion available after sending its synchronous portion. Similarly, differentiated service on the ring is provided by a set of “independent” decisions taken at each node. Thus, at the ring level, the overall bandwidth is not distributed in a differentiated manner.

Possibly the most popular ring architecture used in the practice is the SONET/SDH (Synchronous Optical Network/Synchronous Digital Hierarchy) architecture. A detailed background of SONET/SDH is presented in U.S. Pat. No. 5,335,223. Communication according to the SONET standard makes use of a ring architecture in which a number of nodes are connected by optical links to form a ring. A SONET ring typically has a number of nodes each of which includes an add/drop multiplexer (ADM). Each node is coupled to two neighboring nodes by optical paths. Communication passes around the ring in a series of synchronous fixed-length data frames. SONET does not have a built-in mechanism to dynamically manage bandwidth on the ring. The standards define mechanisms to statically provision resources on the ring—i.e., mechanisms to assign add/drop columns in a SONET frame to each node. However, the SONET standard does not address how to add or drop columns dynamically without shutting traffic on the ring.

### SUMMARY

In a general aspect, the invention provides a method for managing dynamic traffic on a shared medium, for example, on a SONET ring. The method can make use of a central arbiter that communicates with stations coupled to the medium. Each station makes requests to change bandwidth for dynamic traffic entering the medium at that station, and also implements a congestion avoidance algorithm that is coordinated with its requests for changes in bandwidth. The central arbiter responds to the requests from the stations to provide a fair allocation of bandwidth available on the shared medium.

In one aspect, in general, the invention is a method for managing communication on a shared medium with communication capacity that is shared by a number of communication channels. The communication channels are admitted for communicating over the shared medium and each is assigned a priority. A data rate assignment is maintained for each of the communication channels such that a combination of the data rate assignments for the channels does not exceed the communication capacity of the shared medium. Data for the communication channels is passed over the shared medium according to the data rate assignment for each of the communication channel. This includes, for each of the communication channels, accepting data and transmitting the accepted data over the shared medium at a rate limited according to the data rate assignment for the communication channel. Maintaining the data rate assignments for the communication channels includes monitoring communication on each of the communication channels, and generating requests to change data rate assignments for the communication channels using the monitored communication. The requests to change the data rate assignments for each communication channel include requests to increase an assigned data rate for the channel and requests to decrease the assigned data rate for the channel. The data rate assignments are repeatedly recomputed using the received requests.

The method can include one or more of the following features.

Recomputing the data rate assignments includes determining a shares of the communication capacity of the shared medium for each of the priorities of the communication channels, modifying the data rate assignments for communication channels at each priority according to the allocated share for that priority, and for each priority, processing requests for increases in data rate assignments for communication channels at that priority according to the requests and the allocated shared for that priority.

The data rate assignment for each communication channel includes a committed data rate and an assigned data rate. The assigned data rate is maintained to be equal to or to exceed the committed data rate. In recomputing the data rate assignments, a total share of an excess of the communication capacity of the shared medium that exceeds the total committed data rates of the communication channels is determined.

Recomputing the data rate further includes modifying the data rate assignments for the communication channels at each priority, creating a pool of unassigned capacity, and processing requests for increases in data rate assignments for communication channels includes applying the pool of unassigned capacity to said channels.

Processing a request for an increase in data rate assignments for a communication channel at each priority further includes reducing a data rate of another communication channel at the same priority and applying that reduction in data rate to the request for the increase.

Recomputing the data rate assignments includes partially ordering the communication channels at each priority according their past data rate assignments, and reducing a data rate of another communication channel at the same priority includes selecting the another communication channel according to the partial ordering.

Monitoring the data rates for each communication channel include monitoring a size of a queue of data accepted for each channel that is pending transmission over the shared medium and generating the requests to change the data rate assignment for that channel using the monitored size of the queue.

Passing data for the communication channels further includes applying an early dropping (RED) approach in which accepted data is discarded when the data rates for the communication channels exceed their assigned data rates.

The shared communication capacity of the shared communication medium includes a capacity on a SONET network, and the communication channels enter the SONET network at corresponding nodes of the SONET network.

Maintaining the data rate assignments for the communication channels includes maintaining an assignment of a portion of each of a series of data frames to each of the communication channels.

Modifying the data rate assignments for the communication channels includes modifying the assignment of the portion of each of the series of data frames to each of the communication channels.

Passing the requests from the nodes over the SONET ring to an arbiter node, and passing the assignments from the arbiter node to other nodes over the SONET ring.

Maintaining the assigned data rates for the communication channels includes determining a total amount of each of a series of frames passing on the SONET network that are available for the communication channels.

Determining a total amount of each of the series of frames includes determining an amount of each frame assigned to fixed-rate communication channels.

In another aspect, in general, the invention is a communication system. The system includes a shared medium having a communication capacity, and a number of communication nodes coupled to the shared medium configured to pass data for a plurality of communication channels over the shared medium between the nodes. The system also includes an arbiter coupled to the communication nodes and configured to maintain a data rate assignment for each of the communication channels such that a combination of the data rate assignments for the channels does not exceed the communication capacity if the shared medium and to communicate said data rate assignments to the communication nodes. Each communication node is configured to accept data for one or more communication channels and to pass the data over the shared medium according to the data rate assignment for those communication channels. Each node is further configured to pass requests to change data rate assignments for the communication channels according to monitoring of communication on each of the communication channels. The arbiter is configured to determine a share of the communication capacity for each of a plurality of priorities, and to maintain the data rate assignments according to the determined shares for each priority and requests to change data rate assignments passed from the communication nodes.

The shared medium can include a SONET communication system, and the arbiter is configured to maintain an assignment of a portion of each SONET frame to each of the communication channels.

The invention has an advantage of allocating a share of a shared communication capacity according to time varying demands of a number of communication channels in a manner that allocated the capacity both among and within different channel priorities. The approach is applicable to a SONET network, thereby providing a fair mechanism for accommodating bursty communication channels within standard synchronous frames of a SONET framework.

Other features and advantages of the invention are apparent from the following description, and from the claims.

### DESCRIPTION OF DRAWINGS

FIG. 1 is a diagram of a SONET ring in which an arbiter allocates bandwidth for dynamic channels passing over a shared channel on the ring;

FIG. 2 is a block diagram that illustrates components of channel data that is maintained at the arbiter node;

FIG. 3 is a diagram that illustrates allocation of dynamic channels to the link bandwidth of the shared channel;

FIG. 4 is a block diagram of a node on the SONET ring;

FIG. 5 is a block diagram that illustrates interaction of a queue manager and a bandwidth manager with stored queue data at a node;

FIG. 6 is a flowchart that illustrates steps implemented by a central arbiter to allocate bandwidth among different dynamic channels;

FIG. 7 is a flowchart that illustrates steps of a first phase of bandwidth allocation in which bandwidth is allocated among different priorities;

FIG. 8 is pseudocode illustrating steps of a second phase of bandwidth allocation in which particular channels receive increased allocated bandwidth;

FIGS. 9a-b are diagrams illustrating allocations for particular priorities relative to fair shares of bandwidth for those priorities;

FIG. 10 is a diagram that illustrates an example in which channels are in one of four priorities;

FIG. 11 is a diagram that illustrates a step of determining a minimum threshold bandwidth increment for different priorities for the example illustrated in FIG. 10;

FIG. 12 is a diagram that illustrates a step of redistributing bandwidth among different priorities and from an unused pool to different priorities;

FIG. 13 is a diagram that illustrates a step of forming a bandwidth pool for channel increments in a “ripping” procedure;

FIG. 14 is a diagram that illustrates the bandwidth allocations for different priorities in the example;

FIG. 15 is a diagram that illustrates a step of allocating bandwidth to satisfy bandwidth increment requests of particular channels from a pool of unused bandwidth and by preempting the bandwidth allocations of other channels; and

FIG. 16 is a diagram that illustrates a hysteresis based procedure for determining a bin index for each channel based on the history of bandwidth assignments for that channel.

### DESCRIPTION

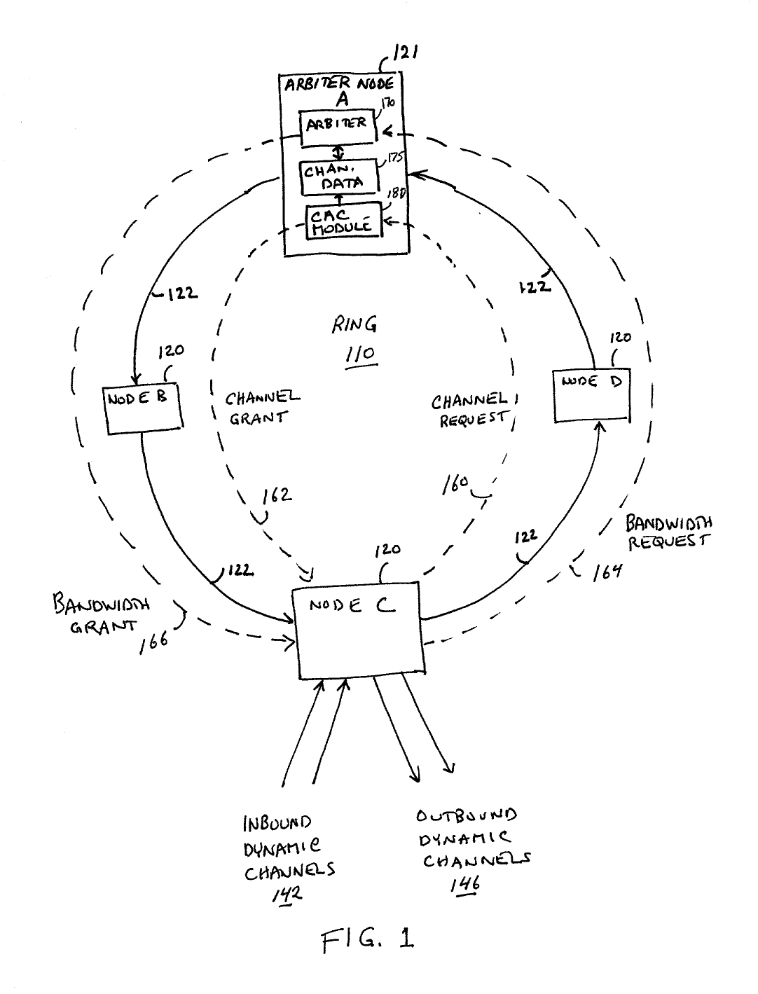

Referring to FIG. 1, a communication system includes a number of nodes 120, 121 that pass data between one another using a capacity-limited shared communication medium. The medium is shared in that communication between one pair of nodes uses a common pool communication capacity that is also used for communication between other pairs of nodes. (In the discussion below, the term “bandwidth” is generally used interchangeably with “communication capacity” or “communication rate” reflecting the feature higher communication rates generally require greater bandwidth in broadband communication systems.) Management of the shared medium according to this invention addresses allocation of the shared medium to competing or potentially conflicting communication over the shared medium. In the embodiment described below, the shared medium has a limit on the total data rate of all communication channels passing over the medium. This limit may be time varying out of the direct control of the management process for allocating capacity within the limited data rate. It should be understood that in alternative embodiments, the shared medium does not necessarily have a time-varying limit of the total communication rate. Furthermore, in alternative embodiments, the shared medium is not necessarily shared such that all communication between nodes uses the same pool of capacity, for example, with communication between one pair of nodes potentially conflicting with communication between only some other pairs of nodes.

According to this invention, the shared communication capacity is allocated to communication channels passing between various pairs of nodes in a time varying manner such that at different times any particular communication channel that is assigned to the shared medium may have a different data rate assigned to it. These communication channels are referred to as “dynamic” channels to reflect their characteristic of not necessarily having a constant demand for data capacity, for example, having a “bursty” nature, and the result that they are managed to not necessarily have a constant data rate allocated for their traffic on the shared medium.

Referring to FIG. 1, in a first embodiment, communication capacity on a SONET ring 110 is allocated according to the invention. A portion of the capacity is reserved for passing a number of dynamic channels between nodes. That is, a portion of the data capacity of SONET ring 110 is the “shared medium” that is managed according to this invention. The number of dynamic channels for communicating between nodes 120 can vary over time as new channels are admitted and removed. In general the admitted channels have dynamically time-varying data rate requirements and are allocated time-varying bandwidth in reaction to the time-varying data rate requirements, while satisfying bandwidth constraints of the shared capacity medium as well as a number of priority and “fairness” criteria.

Communication over SONET ring 110 passes as a series of fixed-length frames at a rate of approximately 8000 frames per second. Each frame is viewed as an array of nine rows of bytes, each with the same number of columns. The total number of columns depends on the overall communication rate of the SONET ring. For example, on an OC1 link there are 90 columns per frame. In this embodiment, the shared communication capacity of the shared medium corresponds to the number of columns of each SONET frame that is available for dynamic channels. The other columns of each SONET frame include columns for overhead communication, and for communication channels that have fixed communication rates, which are often referred to as TDM (time-division multiplexed) channels to reflect the feature that they received a regular periodic portion of the SONET communication capacity.

A central arbiter 170 coordinates the time-varying allocation of the shared capacity to the dynamic channels. This arbiter is hosted at an arbiter node 121 on SONET ring 110. Other nodes 120 make requests of arbiter 170 to change bandwidth allocations for dynamic channels. These requests are generally for dynamic channels entering the ring at the requesting nodes. Arbiter 170 processes the bandwidth requests and informs nodes 120 of the resulting bandwidth allocation associated with each dynamic channel. As is discussed further below, in addition to requesting changes in bandwidth allocation for various dynamic channels, each node 120 also implements a congestion avoidance approach that is coordinated with its requests for bandwidth allocation. This congestion avoidance approach makes use of random dropping of data for dynamic channels that have average queue lengths exceeding particular thresholds.

A representative node C 120 has a number of inbound dynamic channels 142 that enter the ring at that node, and a number of outbound dynamic channels 146 that are “dropped,” or exit, from the ring at that node. Each of the other nodes 120 similarly have inbound and outbound dynamic channels that pass are added or dropped from the ring. In this embodiment, node 121, the arbiter node, optionally includes the functionality hosted at non-arbiter nodes 120, and if so also makes internal requests of arbiter 170 related to allocation of capacity for its inbound channels. It should be understood that each inbound and outbound dynamic channel 142, 146 does not necessarily correspond to a separate physical link. For example, inbound and outbound dynamic channels may be multiplexed in various well-known ways on one more physical links coupled to the nodes.

As introduced above, a portion of each synchronous SONET frame that passes around ring 110 from node to node is reserved for the dynamic channels. This portion is referred to as the “dynamic section” of each frame. The details of this use of a portion of the SONET frames for dynamic data can be found in U.S. Ser. No. 09/536,416, “Transport of Isochronous and Bursty Data on a SONET Ring,” (herein after referred to as the “first application”) which is incorporated herein by reference. In this embodiment, the bandwidth of the dynamic section may vary over time, for example, as more of less bandwidth is allocated to TDM channels also passing over the SONET ring. Operation and management of the TDM channels is described filly in the first application, as well as in U.S. Ser. No. 09/858,019, “Scalable Transport of TDM Channels in a Synchronous Frame,” (hereinafter referred to as the “second application”), which is also incorporated herein by reference.

Management of the dynamic channels involves both provisioning of channels, which includes admission (creation) and termination of channels to the shared channel, as well as bandwidth management of the admitted channels, which includes allocation and deallocation of bandwidth within the shared channel to the admitted channels. Referring to FIG. 1, arbiter node 121 includes a CAC (connection admission control) module 180, which is responsible for creating and terminating the existence of dynamic channels. CAC module 180 maintains data at the arbiter node, which is stored in channel data 175, that characterizes fixed aspects of the dynamic channels. When a representative node C 120 initiates creation of a new inbound dynamic channel 142, it makes a channel request 160 which it transmits to CAC module 180. In this embodiment, node C 120 passes channel request 160 to arbiter node A 121 using an out-of-band (OAM&P) channel linking node C 120 and arbiter node 121. At arbiter node 121, CAC module 180 receives the channel request and if it admits the requested channel it updates channel data 175 according to the request.

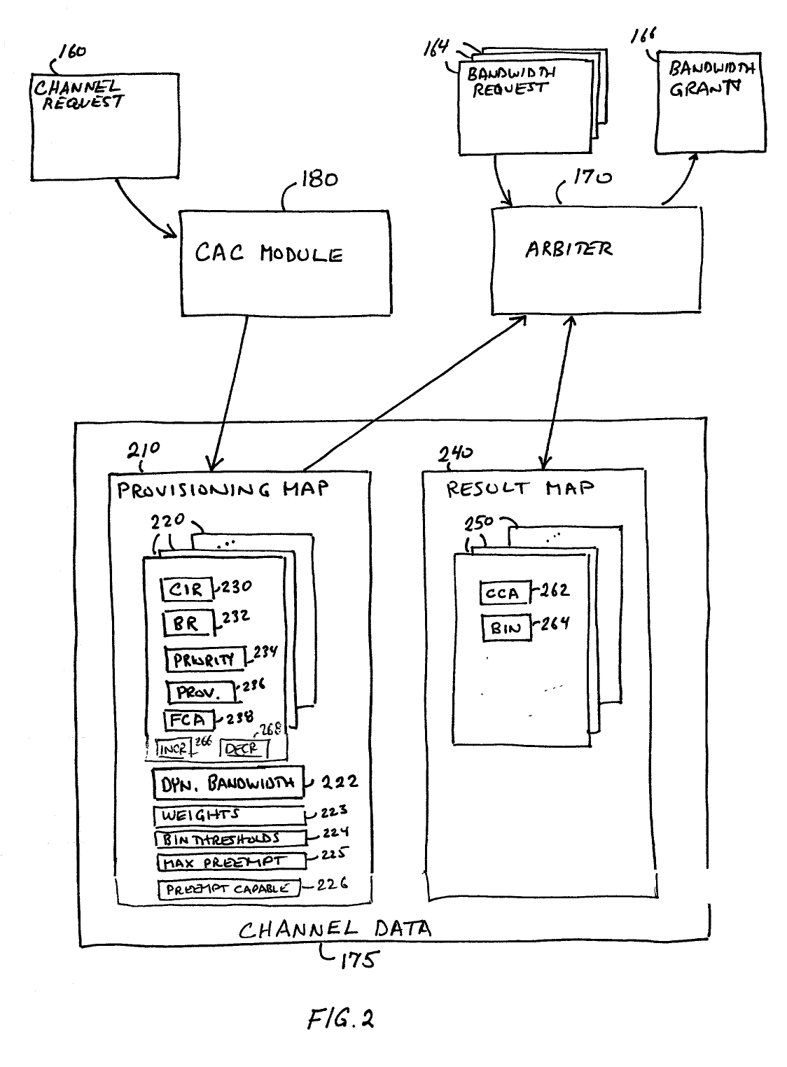

Referring to FIG. 2, CAC module 180 maintains a provisioning map 210 in channel data 175, which includes information about the admitted dynamic channels. CAC module 180 receives channel requests 160, each of which includes information regarding the requested channel, such as its originating node, destination node or nodes, a required bandwidth (data rate), a desired burst data rate, and a priority. In response to the request, CAC module 180 creates a provisioning record 220 for that dynamic channel. Each provisioning record 220 includes a number of data fields, which generally do not change while the dynamic channel is active. The provisioning record includes a CIR (committed information rate) 230, which is the number of columns of each SONET frame that are guaranteed to be available for the dynamic channel. The record also includes a BR (burst rate) 232, which is maximum number of columns of each frame that may be made available by arbiter 170 for this dynamic channel when its data rate demand is high, for example, during bursts. Note that BR 232 includes the committed amount indicated by CIR 230, therefore, BR is greater than or equal to CIR. Each provisioning record also includes a priority 234. Different dynamic channels have different priorities. The management approach described below addresses both allocation of bandwidth between different priorities as well as allocation of bandwidth to different dynamic channels within any particular priority. Provisioning record 220 also includes a provisioned flag 236. In the discussion below the dynamic channels are assumed to have this flag set. Clearing provisioned flag 236 allows a provisioning record to exist for a dynamic channel, but arbiter 170 does not allocate any capacity for it. For example, a dynamic channel that has been idle for an extended time may have its provisioned flag cleared, thereby allowing its committed rate to be used by other channels. Provisioning record 220 for a dynamic channel also includes FCA (fair capacity allocation) 238, which is a quantity in the range from CIR to BR that is used at certain times to allocate capacity among different dynamic channels which are at the same priority in a fair manner. The FCA of each dynamic channel can optionally be updated during each dynamic channel-provisioning event, for example, as a result of addition or deletion of a dynamic channel.

Provisioning map 210 also includes a dynamic bandwidth (DBW) 222, which is the total number of columns of the SONET frames (the shared bandwidth) that may be allocated to dynamic channels, weights 223 that are used by arbiter 170 in allocating bandwidth among the different priorities, bin thresholds 224 that are used by the arbiter in categorizing dynamic channels at a given priority according to their past bandwidth allocations, and max_preempt 225 and preempt_capable 226 which are parameters used by the arbiter in reallocating bandwidth among dynamic channels at a given priority.

Referring again to FIG. 1, when a representative node C 120 makes requests to increase or decrease the allocated bandwidth for a dynamic channel it passes a bandwidth request 164 to arbiter 170 at arbiter node 121. Bandwidth request 164 can be a request to increase or to decrease the bandwidth of one or more channels. In this embodiment, a portion of each SONET frame passing around the ring is reserved for bandwidth requests 164, and within that portion a one-bit flag is reserved for each dynamic channel. The one-bit flag encodes a request to either increase or to decrease the allocation for the corresponding dynamic channel. Therefore, in this embodiment, there is no encoding for a “no change” request. Bandwidth request 164 corresponds to the one-bit flag for the corresponding dynamic channel. Different nodes 120 set different bandwidth requests within a frame as it passes around the ring generally for channels entering the ring at each of those nodes, and arbiter 170 then receives multiple bandwidth requests 164 in each frame it receives.

After processing the bandwidth requests it receives in one or more frames, arbiter 170 sends a bandwidth grant 166 to the nodes. In this embodiment, a portion of each SONET frame is reserved for the bandwidth grants. Bandwidth grants 166 identify which SONET columns that are allocated to each of the dynamic channels. Each node 120 receives bandwidth grant 166 as the SONET frame carrying the bandwidth grant traverses the ring, each node notes any changes to the allocations for the dynamic channels and continues processing the flows for dynamic channels entering or leaving the ring at that node. A node C 120 which makes a request to change the allocation for a channel will receive any grant in response after a delay at least equal to the propagation time for passing frames around the ring. The bandwidth request must first pass from the node to the arbiter, the arbiter must then process the request, and then the grant must pass over the remainder of the ring back to the requesting node.

Referring again to FIG. 2, arbiter 170 make use of the information in provisioning map 210 to maintain a result map 240. Result map 240 includes a result record 250 for each dynamic channel. Based on the bandwidth requests 164 that it receives, arbiter 170 updates result records 250 and forms the bandwidth grants 166 reflecting the data in the result map. Result record 250 for each dynamic channel includes a number of fields. A CCA (current capacity allocation) 262 is the currently assigned number of columns of allocated to the dynamic channel. CCA 262 is constrained to be at least equal to CIR 230 and no greater than BR 232 for that channel. In the discussion below, the difference between CIR and CCA is defined to be CBA, the current burst allocation. A bin 264 is an integer in the range 1 to B that reflects past communication demand by the dynamic channel. As is described more fully below, a channel that has recently had an increase in bandwidth allocation will in general have a higher bin index than channels that have had recent decrements. Channels with a lower bin index receive some preference over channels with a higher bin index at the same priority.

Each dynamic channel also has an INCR 266 and a DECR 268 value. These values are the numbers of columns by which allocation and deallocation requests are scaled. That is, a bandwidth request for a dynamic channel is interpreted by arbiter 170 as a request to increment the number of columns for that channel by INCR, while a request to deallocate bandwidth for the channel is interpreted as a request to deallocate the number of columns for that channel by DECR. INCR and DECR are in general channel-dependent. CAC module 180 sets INCR 266 and DECR 268 values for each dynamic channel. Optionally, CAC module 180 can later modify these values. Based on simulations and laboratory experiments, INCR and DECR of a channel are preferably set at 5-10% of the range between BR and CIR of the channel. The choice of INCR and DECR affects the time dynamics of the overall allocation approach. The particular choice of INCR and DECR is meant to be large enough to provide relatively quick response to changes in data rate demand by the dynamic channels. Furthermore, the sizes of INCR and DECR are chosen to be small enough such that changes to the allocated bandwidths do not adversely interact with higher-level flow control mechanisms, such as TCP-based flow control, by allowing the allocation of bandwidth to change too quickly.

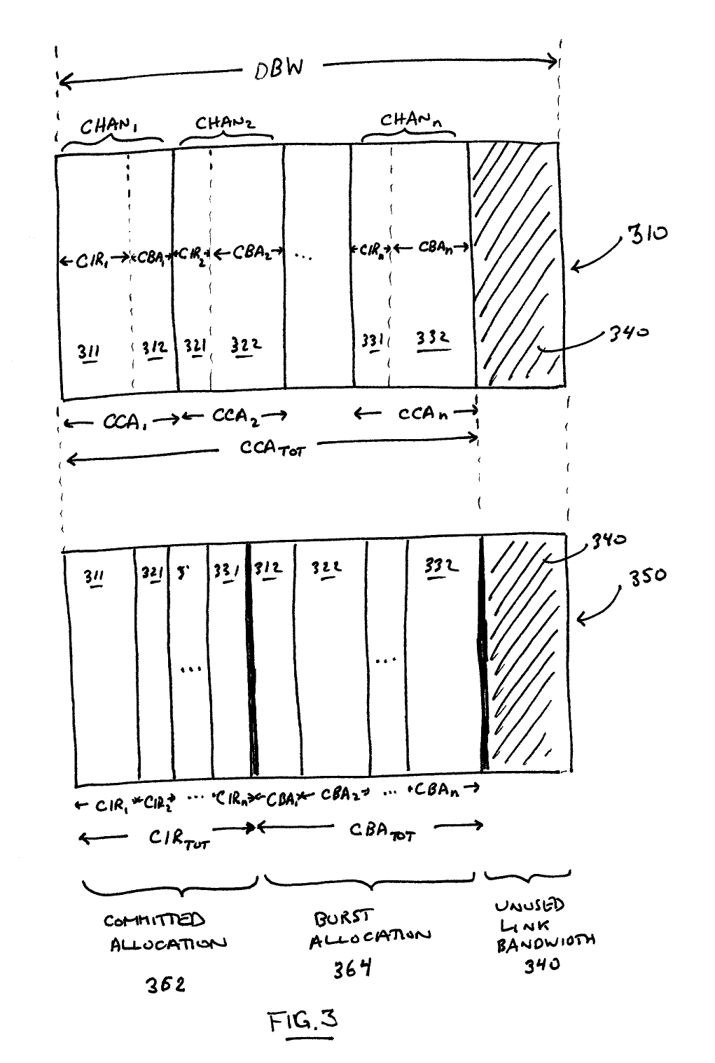

FIG. 3 illustrates two views of the total dynamic bandwidth of the shared medium, recognizing that over time the size of this bandwidth may vary. This entire bandwidth is denoted DBW (dynamic bandwidth). Bandwidth allocation to n dynamic channels is shown in the upper section of FIG. 3 by sections 311-332. In the upper portion of FIG. 3, allocations for each channel are illustrated as contiguous sections. For instance, CCA₁ is illustrated with CIR₁ 311 adjacent to CBA₁ 312. The sum of the CCAᵢ is denoted as CCA_{TOT}, the total current allocation to active dynamic channels. In general, there may be some unused dynamic bandwidth 340 (DBW-CCA_{TOT}), although the arbiter endeavors to allocate the complete dynamic bandwidth to the active channels.

Referring to the lower portion of FIG. 3, the allocation of bandwidth to channels is illustrated in two parts. The committed rates for the active channels (CIR₁ 311, CIR₂ 321, . . . CIRₙ 331) are grouped as the total committed allocation 362, which is denoted as CIR_{TOT}. The burst allocations (CBA₁ 312, CBA₂ 322, . . . CBAₙ 332) are grouped as the burst allocation 364, which is denoted as CBA_{TOT}. As is discussed further below, active dynamic channels are guaranteed their CIR bandwidth. Therefore, arbiter 170 strives to determine the CBAᵢ in a fair manner based on requests to allocated or deallocate bandwidth to several of the dynamic channels while maintaining the committed rates.

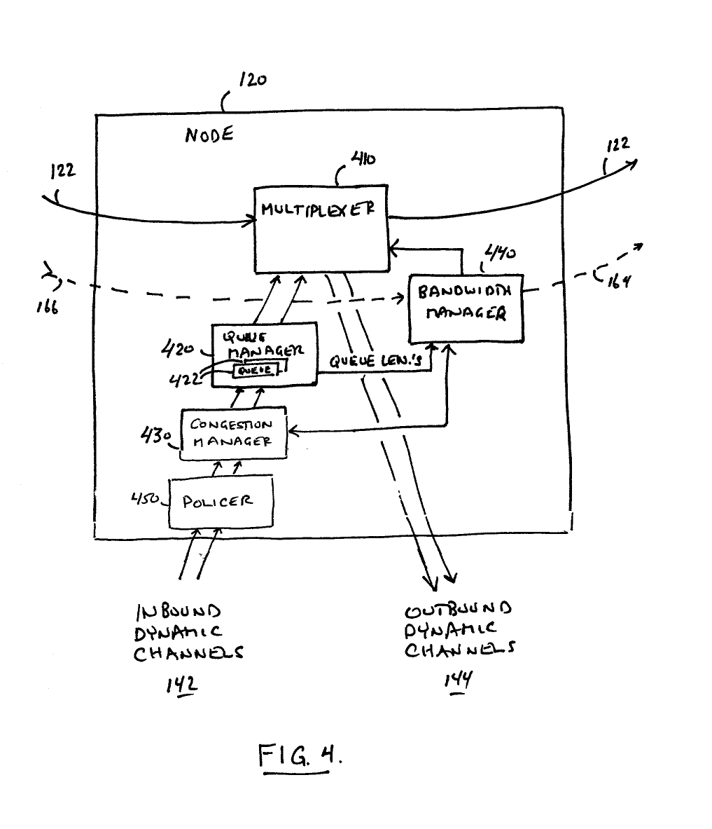

Referring to FIG. 4, each node 120 includes a number of inter-related modules. A multiplexer 410 receives data over a link 122 of SONET ring 110, extracts (drops) data for outbound dynamic channels 144, and adds data for inbound dynamic channels 142 onto the outbound link 122 of SONET ring 110. A bandwidth manager 440 receives control information, including bandwidth grants 166, from arbiter 170. Using this control information, bandwidth manager 440 informs multiplexer 410 which columns of the SONET frame are associated with the inbound and outbound dynamic channels to be added or dropped at that node. A queue manager 420 manages a queue 42 for each inbound dynamic channel, and provides queue length information to bandwidth manager 440. A congestion manager 430 accepts data from a policer 450, and implements a random early dropping (RED) approach to congestion avoidance, which is described fully below, based on queue-length-related parameter provided to it by bandwidth manager 440. Policer 450 accepts data for the inbound dynamic channels and implements a dual leaky bucket approach to police the incoming traffic of the channels to not exceed their respective BRs. Packets arriving at a rate higher than BR are dropped. Each packet arriving at a rate between CIR and BR is tagged by policer 450 as “droppable” by setting a bit in the packet's header. Packets arriving at a rate less than or equal to CIR are forwarded as is without setting the “droppable” bit. Congestion manager 430 uses the droppable bit information to enforce congestion management as described below. At each node 120, congestion manager 430 accepts inbound data from policer 450. Queue manager 420 accepts inbound data from congestion manager 430 and queues that data in a queue 422 for each channel. Queue manager 420 dequeues data from each channel at the rate corresponding to the allocation for that channel. That is, data is dequeued at a rate corresponding to the number of SONET columns allocated for that dynamic channel. Queue manager 420 informs bandwidth manager 440 of the instantaneous queue length for each queue. Bandwidth manager 440 computes a time average (i.e., smoothed version) of the queue length for each channel and determines the bandwidth requests it sends to the arbiter based on these averaged queue lengths. In this embodiment, bandwidth manager 440 samples the actual queue length every t time units, and computes an average according to average[n+1]=(1-w)*average[n−1]+w*length[n], where w is the weight of the new sample length, and n being a counter of the number of updates. For ease of implementation, w is chosen such that it can be derived from powers of 2. The value of w is programmable. In this embodiment, w=0.005=1/256+1/512=2⁻⁹+2⁻¹⁰, and 1-w=0.995=1-1/256-1/512=2⁰−2⁻⁹2⁻¹⁰. Thus, the average computation can be implemented using shift operations. In this embodiment, t is chosen to be in the range 0.1 to 1.0 milliseconds. These values of t and w yield a decaying average with an averaging time constant of approximately 0.2-2 seconds.

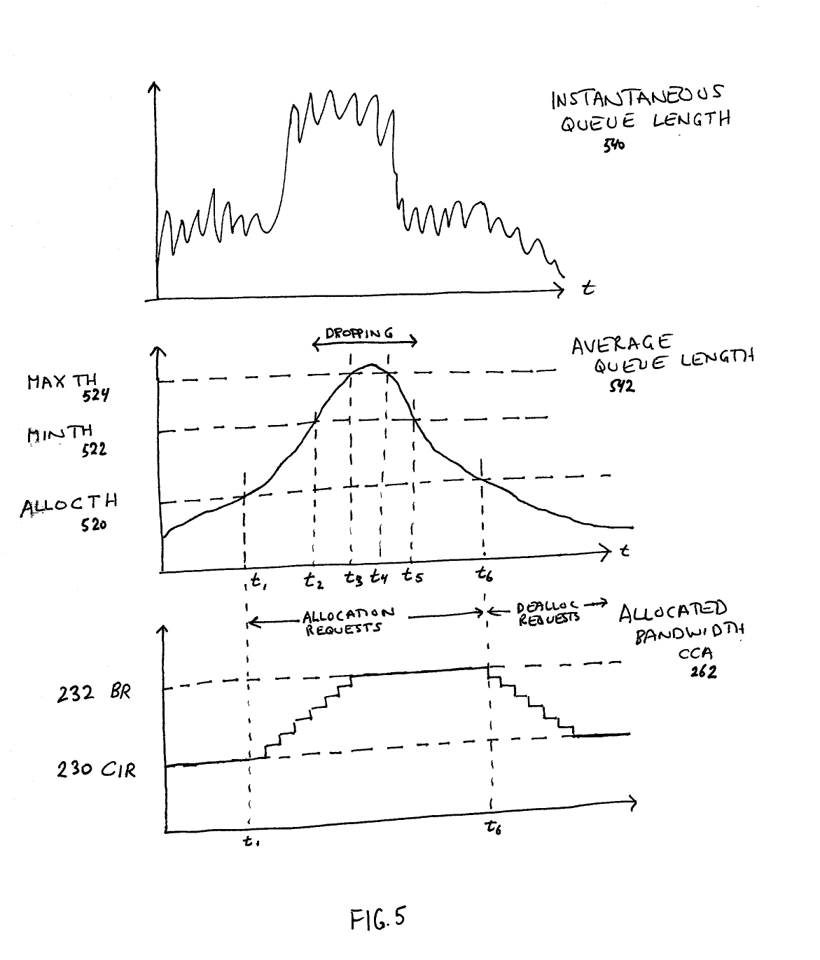

Referring to FIG. 5, three graphs related to a single of the inbound dynamic channels at a node are shown with aligned time axes. These graphs illustrate the operation of queue manager 420 and bandwidth manager 440 (FIG. 4) at the node. The top graph of the figure shows a typical instantaneous queue length 540 for a queue 422 associated with a dynamic channel. The center graph illustrates the corresponding average queue length 542 for that channel. The lower graph illustrates the allocated bandwidth, CCA 262, for the dynamic channel as granted by arbiter 170 and communicated to the node. Bandwidth manager 440 receives the instantaneous queue length 540 from queue manager 420 and computer a time average queue length 542 according to the averaging formula described above. When the average queue length exceeds a configurable threshold, ALLOCTH 520, bandwidth manager 440 sends a bandwidth requests 164 to arbiter 170 in each frame to increase the bandwidth allocation for that dynamic channel. When the average queue length is below ALLOCTH, bandwidth manager 440 sends a bandwidth requests 164 to arbiter 170 to decrease the bandwidth allocation for the channel. In FIG. 5, the period of time from t₁to t₆ corresponds to a period during which the average bandwidth exceeds ALLOCTH and bandwidth manager 440 requests increases in allocation for the channel. After time t₆, when the average queue length again falls below ALLOCTH, bandwidth manager 440 requests deallocation (reduction) of bandwidth for the channel. The bottom graph shows the allocated bandwidth (CCA), as allocated by arbiter 170 in response to the requests from bandwidth manager 440. The process by which arbiter 170 processes bandwidth requests and computes CCA for each channel is discussed further below.

Turning now to congestion manager 430, inbound data received by node 120 for certain inbound dynamic channels 142 is at times discarded if there is a backlog of data for those channels using a technique that is often referred to as random early dropping (RED). In particular, when average queue length 542 is less than a settable threshold, MINTH 722, inbound data is queued and not dropped. When the average queue length exceeds a second settable threshold, MAXTH 724, all droppable packets for that channel is dropped. From MINTH 722 to MAXTH 724, inbound packet that is tagged “droppable” by the policer 450 is actually dropped with a probability that increases with the average queue length.

In this embodiment, an efficient method for determining whether to drop data is based on dividing the range of average queue length from MINTH to MAXTH into R regions, for example in equal increments. Each of the R regions is associated with a different register and that register has a number of randomly chosen bits set to 1 such that the total number of bits that are 1 form a fraction of the total number of bits in the register that is equal to the desired dropping probability for that region. The number of regions and the drop probabilities for the regions are configurable. For example, R=4 regions and drop probabilities of approximately 0.05, 0.1, 0.25, and 0.5, respectively, can be used. The values of R and the drop probabilities are configurable. In different configurations, different numbers of regions and different drop probabilities for the regions can be used. In this embodiment a 64-bit register length is used. Congestion manager 430 determines whether to in fact drop the droppable data using the current average queue length to select the registers associated with the range within which that average queue length falls. Then, a “random” L-bit number is determined and used as a bit index into the register by using the least significant L bits of the current queue length, where L is log₂(register length). If the register length is 64, L=6. If the indexed bit is 1, then the data is dropped, otherwise the data is enqueued.

Hard drops occur when the instantaneous queue length of a channel is greater than the queue size of the channel. In such a case, all packets (droppable or not) are dropped for the channel. In FIG. 5, at times prior to t₂ data is not dropped since the average queue length is below MINTH. Between times t₂ and t₃, while the average queue length is between MINTH and MAXTH, droppable data is randomly dropped using the register approach described above. From time t₃ to time t₄, all droppable packets are dropped since the average queue length exceeds MAXTH. From time t₄ to time t₅, droppable packets are again randomly dropped, and dropping ceases at time ts when the average queue length falls below MINTH.

Note that operation of bandwidth manager 440 and congestion manager 430 is coordinated through use of average queue lengths to affect operation of both modules. For example, since ALLOCTH is generally lower than MINTH, bandwidth manager requests a increase in allocation for the channel some time before congestion manager 430 will start dropping data for that channel. That is, if arbiter 170 allocates additional capacity to the channel in response to the requests that start when the average queue length crosses ALLOCTH, then the average queue length may be controlled to not rise above MINTH. However, if capacity is not allocated to the channel, for example, because it is not available, or because that channel has a relatively low priority compared to other active dynamic channels, then congestion manager 430 begins to randomly drop data to control the length of the queue.

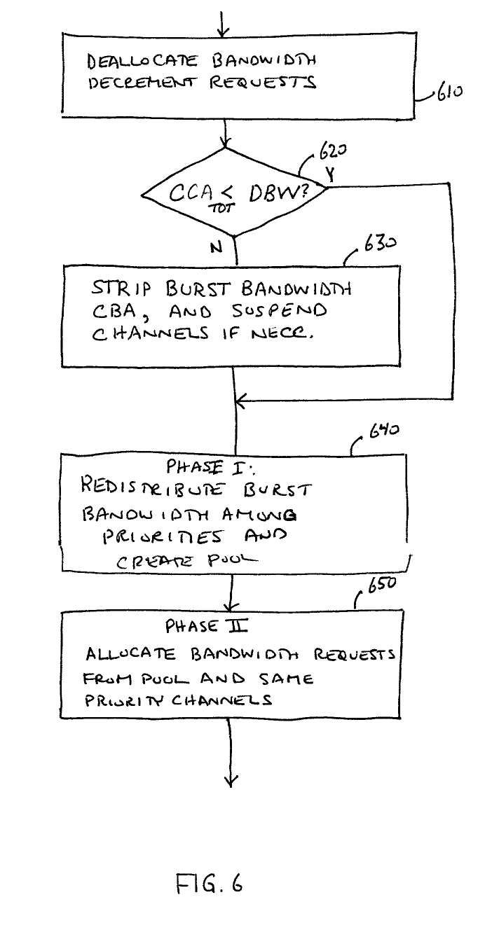

Arbiter 170 implements the decision process by which bandwidth is allocated to the dynamic channels. This decision process is largely independent of specific queue lengths. Arbiter 170 responds to the bandwidth requests from the bandwidth managers 440 at the various nodes, and maintains a limited history related to its allocations to various channels. Referring to FIG. 6, arbiter 170 repeats as series of steps, in this embodiment, after every three SONET frames it receives. In alternative embodiments, these steps may be initiated on every frame, at fixed interval, or at other regular repetition times or upon demand.

At step 610, arbiter 170 first acts upon bandwidth deallocation requests for all channels requesting deallocation. For each channel j whose bandwidth request is a deallocation, arbiter 170 decrements CCAⱼ by AMTⱼ, where AMTⱼ=MIN(DECRⱼ, CBAⱼ). This reduces CCA_{TOT} accordingly, which is the sum of the CCAⱼ taking into account the decrements.

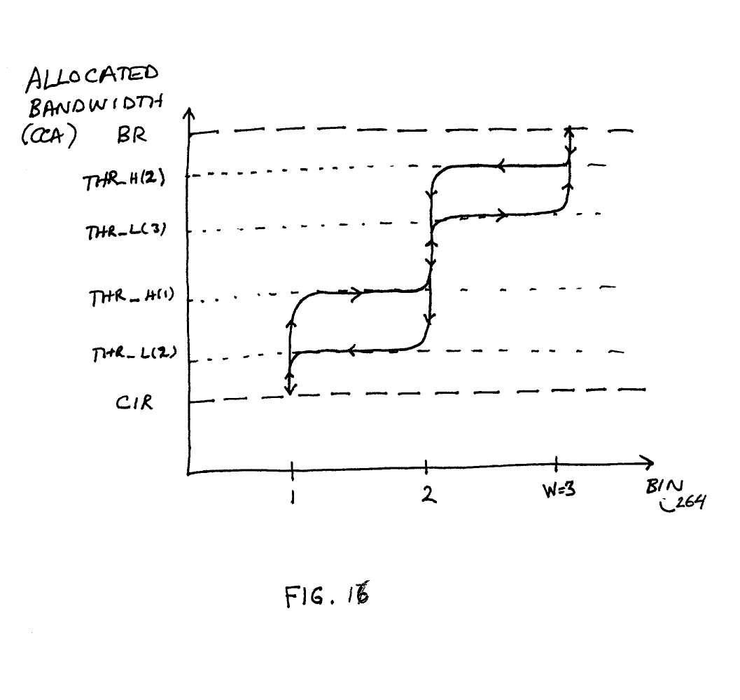

As arbiter 170 modifies the bandwidth allocation for each channel, for instance acting on a decrement request an increment request or preempting bandwidth from a channel to satisfy an increment for another channel, the arbiter maintains a bin value for each channel. As introduced above, bin 264 is an integer in the range 1. . . B, and is computed using a time history of the allocated bandwidth (CCA) for the channel. In this embodiment, B=3, although alternative numbers of bins can be used. Referring to FIG. 16, bin 264 is computed using hysteresis to increase as CCA increases from CIR to BR, and then to decrease as CCA falls from BR to CIR. Initially, a channel is in bin 1. As CCA increases above THR_H(1), the bin is changed to 2, and when CCA increases above THR_H(2), the bin is changed to 3. As CCA is reduced below THR_L(3), the bin changes to 2, and as CCA is reduced below THR_L(2), the bin changes to 1. As described below, by assigning bins to different channels at a particular priority, channels that are closer to CIR are generally preferred when arbiter 170 determines which channels are to receive their requested bandwidth increments and which are to be preempted.

Continuing with the processing, at step 620, arbiter 170 checks to see whether the current allocation, CCA_{TOT}, exceeds the current dynamic bandwidth, DBW. Note that the dynamic bandwidth itself may change over time, for example, due to an increase in the allocation for TDM channels, which consequently may reduce the remaining allocation for dynamic channels. Also, new dynamic channels may have been admitted by CAC module 180 and allocated their committed rates (CIR), thereby potentially causing CCA_{TOT} to exceed DBW, which itself did not change. It should be noted that even if the TDM allocation increases, CAC module 180 always ensure that there is at least CIR_{TOT} amount of bandwidth to the dynamic channels. That is, the CIR portion of the bandwidth will always be available.

If the current allocation does not in fact fall below the current dynamic bandwidth, DBW, at step 630, arbiter 170 performs a stripping procedure. In this stripping procedure, arbiter reduces the bandwidth allocation for one or more channels. It chooses channels first in order of increasing priority. The highest priority is 1. That is, it first reduces the bandwidth allocation for channels at priority P, then at priority P-1, and then higher priorities in turn. In this stripping procedure, the arbiter does not reduce any channel's allocation below its CIR; rather it reduces allocations CCA, which in general may exceed CIR, to be equal to CIR. Within each priority, the arbiter first strips bandwidth from channels it the highest index bin, B, then the next higher index, and so forth until it has stripped bandwidth from bin index 1. Within each bin, the arbiter cycles through the channels i decrementing its CCA by MIN(DECRᵢ, CBAᵢ) completing the stripping of the bin when all the channels are allocated their minimum CIR. Arbiter 170 completes this stripping procedure when it has reduced CCA_{TOT} to be less than DBW, or alternatively, when it has reduced all the active channels to their committed rates, CIR.

If the sum of the committed rates, CIR_{TOT}, still exceeds the total dynamic bandwidth, DBW, after reducing all the dynamic channels to their committed rates, the stripping procedure also includes de-provisioning channels in the same order as in the first part of the stripping procedure. De-provisioning involves clearing the provisioned flag and setting the allocation, CCA, to zero, thereby essentially removing the de-provisioned channels from the bandwidth allocation procedure. However, as stated above, this should never happen if the CAC module works properly.

Arbiter 170 next addresses the requests to allocate additional bandwidth in a series of two phases. At step 640, the arbiter performs a first phase that redistributes the burst bandwidth among the priorities and creates a pool of bandwidth for some (but not typically all) of the bandwidth allocation requests. At step 650, in the second phase the arbiter allocates bandwidth to some (but not necessarily all) channels requesting increases in their bandwidth allocation. These requests are satisfied from the bandwidth pool created in the first phase, or by preempting the allocations of channels at the same priorities as the channels requesting increases.

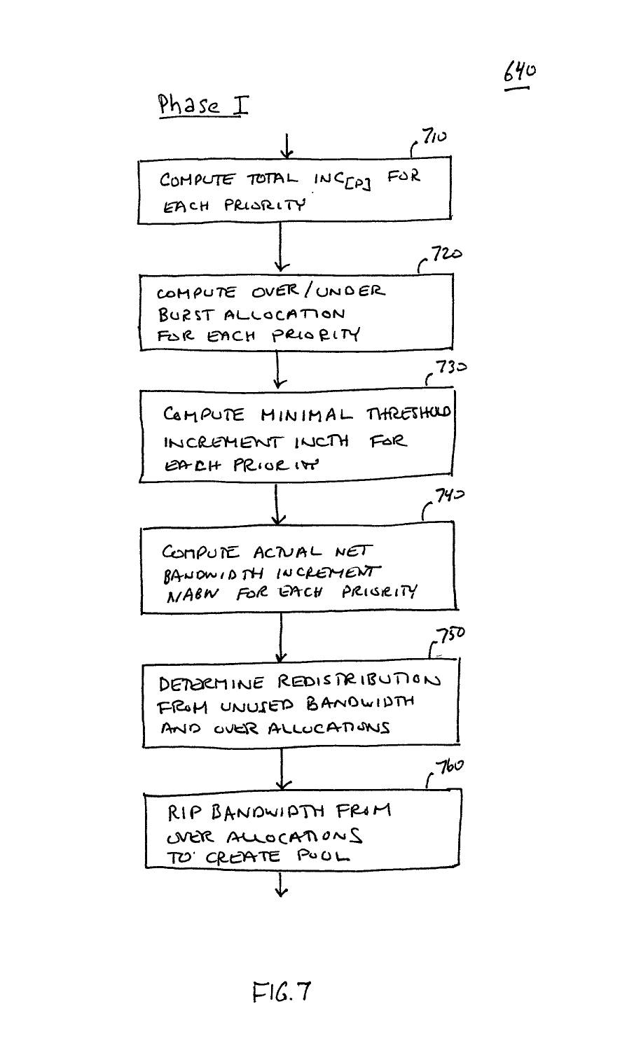

Referring to FIG. 7, in the first phase, arbiter 170 first computes the total requested increase, INC_{[p]}, for each priority p (step 710). (In general, subscripts in square brackets refer to a quantity associated with a particular priority, and subscripts without brackets refer to quantities associated with particular dynamic channels.) The total request for a priority p is computed as the sum of MIN(INCRᵢ,BRᵢ-CCAᵢ) for all channels i at priority p which have their bandwidth request bit set indicating a request to increase their allocation. Limiting the contribution of a channel i to BRᵢ-CCAᵢ reflects the feature that the arbiter will not honor requests to increase a bandwidth allocation beyond the set burst rate, BRᵢ, for a channel.

At step 720, arbiter 170 determines the amount by which each priority's allocation is either over or under its “fair” share. Each priority has an associated “weight” w_{[p]} 223. In general, the higher the priority (lower priority index p) the greater the value of w_{[p]}. In this embodiment, these weight are integers in units of the smallest increment to bandwidth allocation that is available for the shared medium, in this embodiment, in units of SONET columns. Of the dynamic bandwidth, DBW, part is associated with the committed rates for the dynamic channels. The remainder is the burst bandwidth, which the arbiter is free to allocate to the burst allocations the various channels. The total burst bandwidth is denoted TBW=DBW-CIR_{TOT}. Each priority has an associated fair share of the total burst bandwidth. This fair share, TBW_{[p]}, is proportional to its weight, TBW_{[p]}=TBW*w_{[p]}/sum(w_{[q]}).

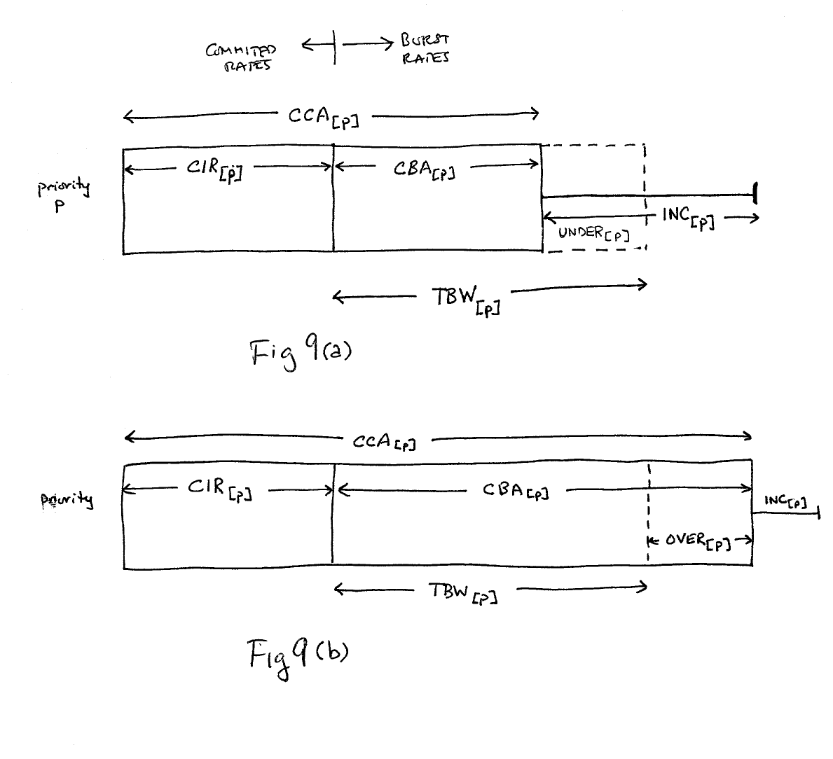

The sum of the allocations CCAᵢ. for channels i at priority p is denoted CCA_{[p]}, the sum of the committed allocations CIRᵢ for channels i at priority p is denoted CIR_{[p]}, and the total burst bandwidth allocation for a priority is denoted CBA_{[p]}=CCA_{[p]}-CIR_{[p]}. For each priority p, if CBA_{[P]} is less than or equal to TBW_{[p]}, priority p is under its fair share of the burst bandwidth and UNDER_{[p]}=TBW_{[p]}-CBA_{[p]}. If CBA_{[P]} exceeds TBW_{[p]}, priority p is over its fair share and OVER_{[p]}=CCA_{[p]}-TBW_{[p]}. Referring to FIG. 9a, the allocation for a priority that is under its fair share is diagrammed in terms of the quantities described above. In FIG. 9b, a priority that is over its fair share is similarly diagrammed.

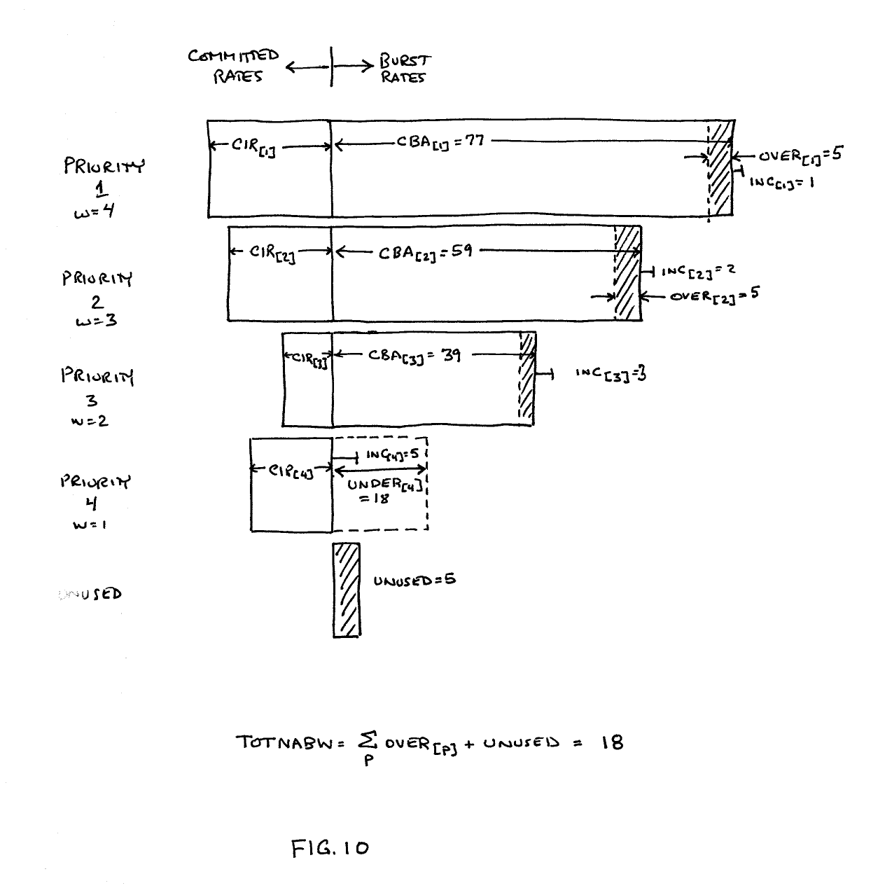

Referring to FIG. 10, an example involving four priorities is illustrated using the diagramming approach illustrated in FIGS. 9a-b. Note that for the purpose of this example, the specific values of the committed rates for each priority, or their total, are not relevant. In this example, the total burst bandwidth, TBW, is 180 (measured in units of SONET columns). The weights for the priorities, w_{[1 . . . 4]}, are 4, 3, 2, and 1, respectively, yielding fair shares of the burst bandwidth, TBW_{[1 . . . 4]} of 72, 54, 36, and 18 respectively. The current burst allocations, CBA_{[1 . . . 4}] are 77, 59, 39, and 0 respectively. Therefore, priorities 1, 2 and 3 are over their fair shares of the burst bandwidth:

OVER_{[1]}=5, UNDER_{[1]}=0,

OVER_{[2]}=5, UNDER_{[2]}=0, and

OVER_{[3]}=3, UNDER_{[3]}=0, while priority 4 is under its fair share: OVER_{[4]}=0, UNDER_{[4]}=18. This example relates to a single iteration of the arbiter's allocation procedure, in which the total requested increases for each priority, INC_{[1 . . . 4]}, are 1, 2, 3, and 5, respectively. Note that FIG. 10 reflects the situation after the initial deallocation (FIG. 6 step 610) has already taken place. In this example, the total burst allocation, CBA_{TOT}=175. Since the total burst allocation, TBW, is 180, there is an unused capacity of 5 that is not assigned to any channel.

The total amount priorities are over their fair shares, as well as the unused bandwidth, form a net available burst bandwidth, TOTNABW. Generally, the net available burst bandwidth forms a pool of bandwidth used to satisfy requests to increase bandwidth allocations.

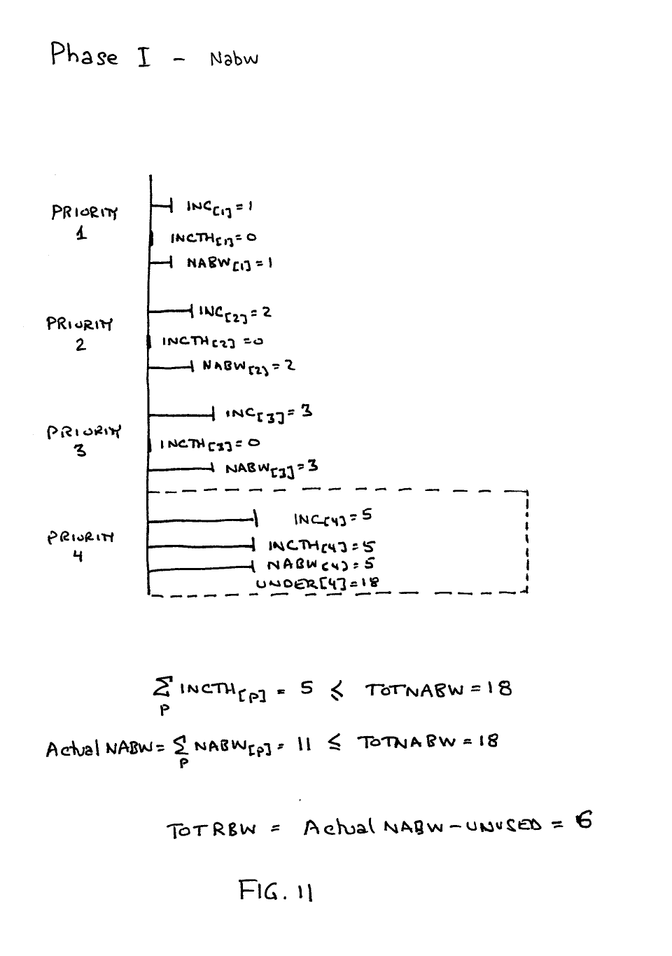

At step 730 (FIG. 7), arbiter 170 computes a minimum threshold amount by which the total allocated bandwidth for each priority will be increased in the bandwidth allocation procedure. Referring to FIG. 11, this is illustrated diagramatically for each priority. For each priority p that is under its fair share of the burst bandwidth, UNDER_{[p]} is illustrated with a broken line. The total requested bandwidth, INC_{[p]}, is illustrated as a bar. For each priority, the minimum increase for that priority, INCTH_{[p]}, is computed as MIN(INC_{[p]}, UNDER_{[p]}) and also illustrated as a bar. At this step, the resulting values for INCTH_{[1 . . . 4]} are 0, 0, 0, and 5, respectively. Since priorities 1, 2 and 3 are already exceeding its fair share, their minimum increases are zero. The minimum increase for priority 4 is limited to the increase amount that the priority is requesting. Note that the sum of these minimum thresholds, in this case 5, will be less than or equal to the net available burst bandwidth, TOTNABW=18.

At step 740 (FIG. 7) arbiter 170 augments the amount by which each priority will receive an increased allocation using a weighted approach. Generally, the net available bandwidth for incrementing allocations at a priority, NABW_{[p]}, is the minimum increment, INCTH_{[p]}, plus an amount generally proportional to wₚ, without going over INC_{[p]}. In this embodiment, arbiter 170 initializes the NABW_{[p]}=w_{[p]}, for each priority p, and then repeatedly cycles through the priorities incrementing NABW_{[p]} by AMT, where AMT=MIN(w_{[p]}, left) where left=MIN((NABW_{[p]}-INCTH_{[p]}), (TOTNABW-sum of NABW_{[p]})), while left>0. Once the NABW_{[P]} for a priority p reaches its INCTH_{[p]}, it stops incrementing that priority. After all priorities have reached their INCTH_{[p]}, the arbiter 170 repeatedly cycles through the priorities incrementing NABW_{[p]} by AMT, where AMT=MIN(w_{[p]}, left) where left=((NABW_{[p]}-INC_{[p]}), (TOTNABW-sum of NABW_{[p]})), while left>0. FIG. 11 illustrates this step for the simple example introduced in FIG. 10, with the result that ActualNABW, the sum of the NABW_{[p]}, is 11, and the individual NABW_{[1 . . . 4}] are 1, 2, 3, and 5, respectively. Of ActualNABW, a portion is satisfied from the unused bandwidth, UNUSED=5, while the rest comes from the priorities that are over their fair share in a process termed “ripping.” In particular, the total amount that may be ripped from these over share priorities is TotalRBW=ActualNABW-UNUSED=6.

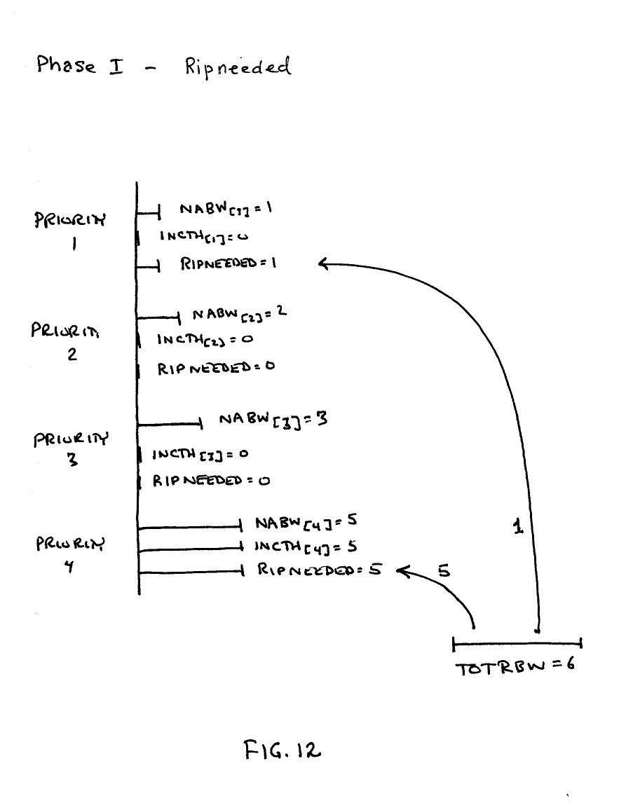

Before redistributing the burst bandwidth, the arbiter determines for each priority k, the portion of the TotalRBW that is needed by each priority, RBWNeeded_{[k]} (step 750). Referring to FIG. 12, this is determined in the same manner as NABWs, except of course instead of TOTNABW, TotalRBW is used. In this example, 6 units of capacity are available. Only priority 4 has INCTH greater than zero, in this case 5. Therefore, RBWNeeded_{[4]} first increases to 5. Only one unit of capacity of the Total RBW=6 is then available, and this results in RBWNeeded_{[1]}=1. This completes this procedure yielding RBWNeeded_{[1 . . . 4]} of 1, 0, 0 and 5, respectively.

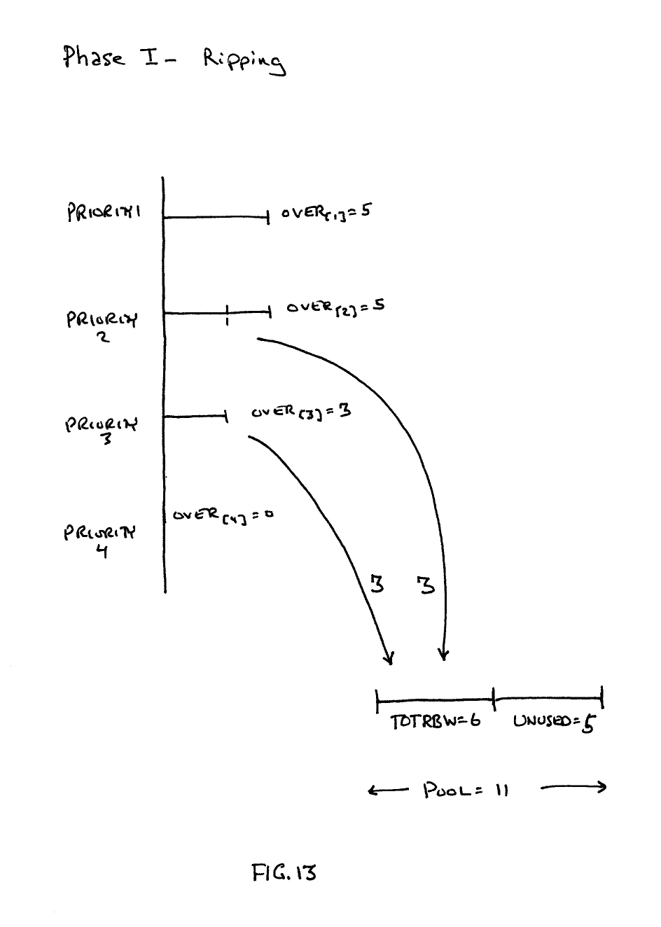

At step 760 (FIG. 7), arbiter 170 forms a bandwidth pool by first starting with the unused bandwidth, and then ripping a total of TotalRBW from the priorities p for which over_{[p]}>0, starting at priority P until TotalRBW is satisfied. The amount ripped from each priority is BWripped_{[p]}. Referring to FIG. 13, in this example, starting at p=4, over_{[4]}=0 so there is no bandwidth to rip. At p=3, over_{[3]}=3, so BWripped_{[3]}=3 units are ripped. At p=2, over_{[2]}=5. Only 3 more units are needed, soBWripped_{[2]}=3. Priority p=1 does not need to be considered since TotalRBW has already been satisfied, so BWripped_{[1]}=0. At this point, arbiter 170 has created a pool of TotalRBW+Unused=11 units by ripping BWripped_{[p]} units from each priority. Priorities 1 . . . 4 expect to receive 1, 2, 3, and 5 units, respectively, from the pool at a subsequent step.

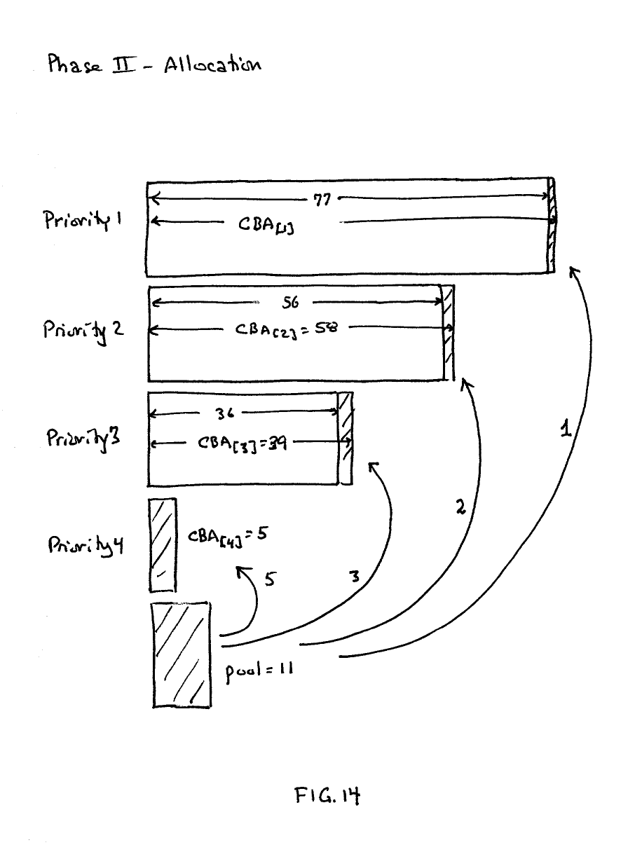

Arbiter 170 rips bandwidth from each priority by decrementing reducing the bandwidth allocations of channels from CCAᵢ to CIRᵢ, starting with channels in the highest index bin and working up to bin 1 until BWripped_{[p]} has been satisfied. At each priority, this procedure is similar to the “stripping” procedure that was described above in the case that the initial allocation is greater than the total dynamic bandwidth. This completes the first phase of the arbiter's bandwidth assignment process. In FIG. 14, the burst bandwidth allocation after ripping is illustrated for the example using solid lines, while the burst bandwidth allocation prior to ripping is illustrated in hatched regions lines. In addition, the total amount that each priority's allocation will be increased in subsequent steps is illustrated by the bars of length NABW_{[p]} extending from the end of the solid bars. The bandwidth pool of size 11 is formed by 5 units from the previously unused bandwidth, 3 units from each of priorities 2 and 3.

Referring back to FIG. 6, the arbiter 170 completes the reallocation procedure in phase II (step 650) in which it allocates bandwidth requests from the pool, and within the same priorities by preempting burst bandwidth of certain channels to satisfy the bandwidth increments for other channels.

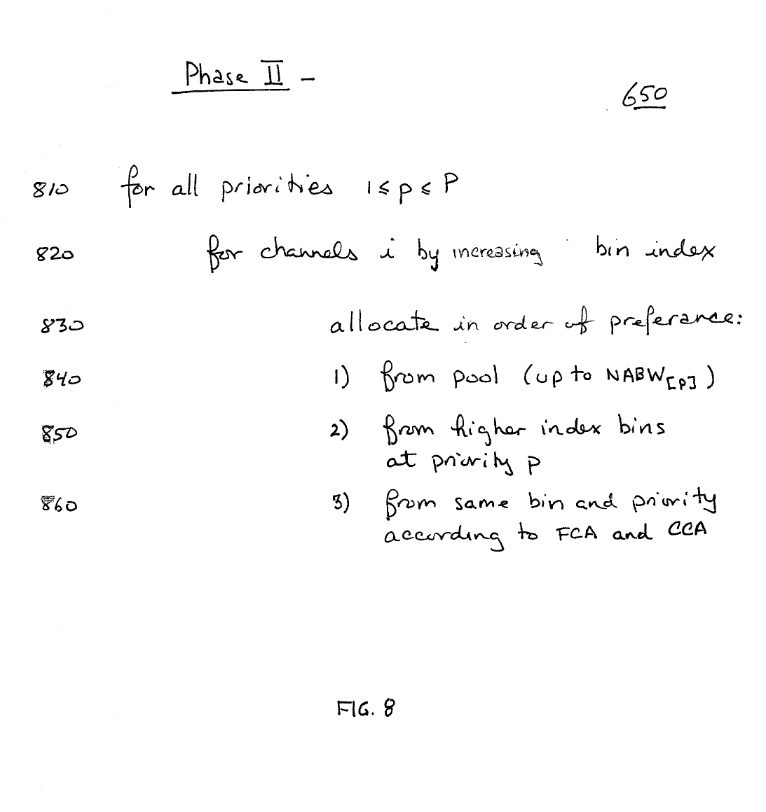

Referring to FIG. 8, the allocation of bandwidth requests for particular channels in performed by first looping over the priorities (line 810). The order of this loop is not significant since allocation in each priority is performed independently of the other priorities at this point at which the bandwidth pool has already been formed.

Within a priority, the channels that have requested increases in bandwidth are considered in turn according to their bins. Channel in the lowest bin index, bin 1, are considered first, then bin 2, up to bin B.

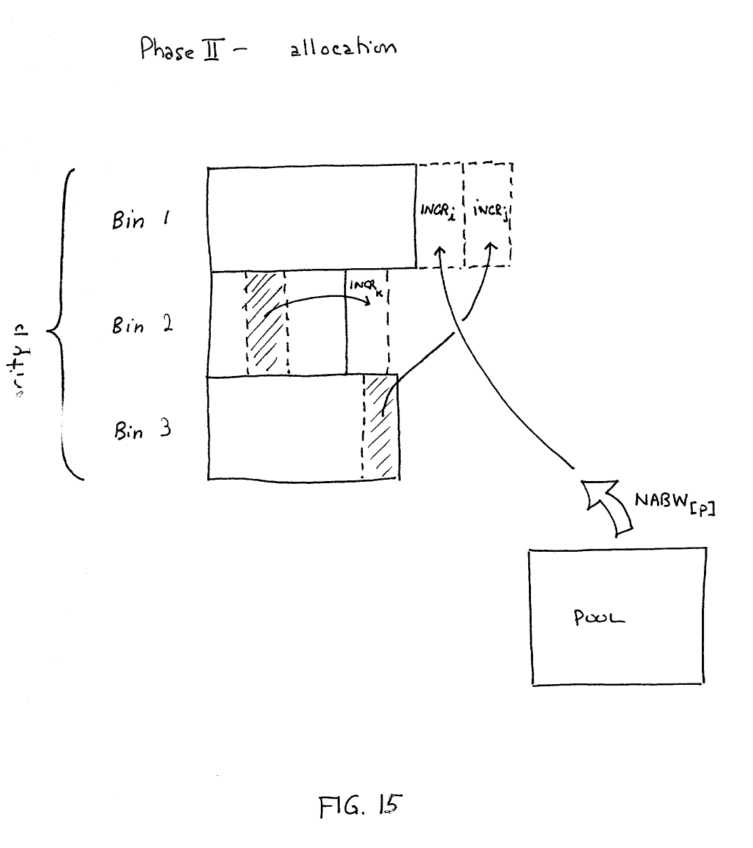

A channel i that is considered may receive at most MIN(INCRᵢ,BRᵢ-CCAᵢ) so that its resulting bandwidth allocation does not exceed BRᵢ. The first NABW_{[p]} of the increments come directly from the bandwidth pool that was created during phase I. Once the priority's share of the pool is exhausted, increment requests may be satisfied by reducing the burst allocation of other channels at the same priority in a process termed “preemption.” Channels at bin B are preempted first, and when the available preemption from bin B is exhausted, bin B-1 is preempted, and so forth. This process is illustrated in FIG. 15. Channel i is illustrated as satisfying its increment, INCRᵢ, from the pool. Channel j is illustrated as satisfying its increment by preempting channels in bin 3. Channel k is illustrated as satisfying its increment from a channel in the same bin.

For each bin b, at each priority p, arbiter 170 is configured to preempt each channel a settable number (MAX_PREEMPT_{[p,b]}) 225 of times in order to satisfy increments for channels at lower index bins. This seftable number can be set to zero to prevent a bin from ever being preempted. Once the preemption process has cycled through the channels in that bin the set number of times, the next lower bin is used for preemption. In addition, there is a settable parameter (PREEMPT_ENABLE_{[p,b]}) 226, for each bin at each priority, that determines if the channels in the bin can preempt channels in other bins within the same priority.

While iterating through the channels that have requested increments, at some point there will typically not be any channels in bins with higher bin indexes from which to preempt bandwidth. The next phase of preemption involves preempting bandwidth from other channels at the same priority and bin as the channel requesting the increment. Recall that as shown in FIG. 2, the provisioning record 220 for each channel includes a fair capacity assignment (FCA) 258. This bandwidth quantity is in the range from CIR to BR for that channel. The general rule for preemption within a same bin is that a channel i for which CCAᵢ<FCAᵢ can only preempt bandwidth from other channels j in the same bin if their CCAⱼ>FCAⱼ. Channels for which CCAᵢ is greater than FCAᵢ can preempt from other channels j in the same bin which satisfy the two conditions that first, their CCAⱼ are also greater than the respective FCAⱼ and second that CCAᵢ is less than CCAⱼ.

Once all the possible preemption in the same bin has been performed, the remaining channels at that priority that have requested increased bandwidth do not have their requests satisfied because there are no more channels from which to preempt bandwidth.

As is described further below following the description of this first embodiment, this approach to managing a shared medium is applicable in a number of alternative embodiments that do not necessarily involve SONET based communication. For example, alternative embodiments of the bandwidth management approach are applicable to shared media such as shared access busses, shared wired network links, and shared radio channels.

In the embodiment described above, arbiter 170 is hosted at a node in the network and requests and grants of bandwidth changes are transported using the same mechanism as the data itself. In alternative embodiments, the arbiter does not have to communicate with the nodes using the shared medium used for data, and does not necessarily have to be hosted on a node in the network.

In alternative embodiments, each “channel” that is assigned bandwidth by the arbiter does not necessarily correspond to a single data stream coming in on one inbound channel at a node and exiting at one outbound channel at another node. Other examples include the following. Each channel can correspond to broadcast or point-to-multipoint communication that exits at a number of different nodes. The channel can be an aggregation of sub-channels. Such sub-channels can share common originating and destination nodes. The sub-channels can also be grouped by other characteristics, such a serving particular customers. A channel can also originate at multiple nodes in multipoint-to-point and multipoint-to-multipoint communication.

In the embodiment described above, arbiter 170 is implemented in hardware. In alternative embodiments, the arbiter 170 may be implemented in software that is stored on a computer readable medium at the arbiter node and causes a processor to execute instructions that implement the bandwidth allocation procedure described above. Alternative embodiments make use of some but not necessarily all of the features of the bandwidth allocation approach. The approach to allocate bandwidth among different priorities can be used independently of the approach of binning channels as allocating and preempting bandwidth at a particular priority. Furthermore, the described embodiment can use a single bin (B=1) effectively not making use of the binning approach. Similarly, alternative embodiments can make use of a single priority (P=1), and still take advantage of the bin-based approach for deciding which channels will receive bandwidth increments.

It is to be understood that the foregoing description is intended to illustrate and not to limit the scope of the invention, which is defined by the scope of the appended claims. Other embodiments are within the scope of the following claims. What is claimed is:

1. A method for managing communication on a shared medium with communication capacity that is shared by a plurality of communication channels comprising:
admitting the communication channels for communicating over the shared medium, including assigning a priority to each of the channels;
maintaining a data rate assignment for each of the communication channels such that a combination of the data rate assignments for the channels does not exceed the communication capacity of the shared medium; and
passing data for the communication channels according to the data rate assignment for each of the communication channel, including for each of the communication channels, accepting data and transmitting the accepted data over the shared medium at a rate limited according to the data rate assignment for the communication channel;
wherein maintaining the data rate assignments for the communication channels includes
monitoring communication on the communication channels,
generating requests to change data rate assignments for the communication channels using the monitored communication, wherein the requests to change the data rate assignments for each communication channel include requests to increase an assigned data rate for said channel and requests to decrease the assigned data rate for said channel, and
repeatedly recomputing the data rate assignments using the received requests.

2. The method of claim 1 wherein recomputing the data rate assignments at the arbiter includes:
determining a shares of the communication capacity of the shared medium for each of the priorities of the communication channels,
modifying the data rate assignments for communication channels at each priority according to the allocated share for that priority; and
for each priority, processing requests for increases in data rate assignments for communication channels at that priority according to said requests and the allocated shared for said priority.

3. The method of claim 1 wherein the data rate assignment for each communication channel includes a committed data rate and an assigned data rate, wherein the assigned data rate is maintained to be equal to or to exceed the committed data rate, and wherein in recomputing the data rate assignments, determining the share of the communication capacity of the shared medium for each priority includes determining a total share of an excess of the communication capacity of the shared medium that exceeds the total committed data rates of the communication channels.

4. The method of claim 3 recomputing the data rate further includes modifying the data rate assignments for the communication channels at each priority includes creating a pool of unassigned capacity, and processing requests for increases in data rate assignments for communication channels includes applying the pool of unassigned capacity to said channels.

5. The method of claim 4 wherein processing a request for an increase in data rate assignments for a communication channel at each priority further includes reducing a data rate of another communication channel at the same priority and applying that reduction in data rate to the request for the increase.

6. The method of claim 1 wherein recomputing the data rate assignments includes partially ordering the communication channels at each priority according their past data rate assignments, and reducing a data rate of another communication channel at the same priority includes selecting the another communication channel according to the partial ordering.

7. The method of claim 1 wherein monitoring the data rates for the communication channels include monitoring a size of a queue of data accepted for the channels that is pending transmission over the shared medium and generating the requests to change the data rate assignment for the channels using the monitored size of the queue.

8. The method of claim 7 wherein monitoring the data rates for the communication channels further includes computing a time average of the monitored size of the queue of data.

9. The method of claim 1 wherein passing data for the communication channels further includes applying an early dropping approach in which accepted data is discarded when the data rates for the communication channels exceed their assigned data rates.

10. The method of claim 1 wherein maintaining the data rate assignment for each channel includes maintaining a committed data rate for each channel, and wherein recomputing the data rate assignments includes providing at least the committed data rate to each channel.

11. The method of claim 1 wherein maintaining the data rate assignment for each channel includes maintaining a limit on the data rate for each channel, and wherein recomputing the data rate assignments includes applying the limit on the data rate for each channel.

12. The method of claim 1 wherein the shared communication capacity of the shared communication medium includes a capacity on a SONET network, and the communication channels enter the SONET network at corresponding nodes of the SONET network.

13. The method of claim 12 wherein maintaining the data rate assignments for the communication channels includes maintaining an assignment of a portion of each of a series of data frames to each of the communication channels.

14. The method of claim 13 wherein modifying the data rate assignments for the communication channels includes modifying the assignment of the portion of each of the series of data frames to each of the communication channels.

15. The method of claim 14 wherein passing the requests to the arbiter include passing said requests for the nodes over the SONET ring to an arbiter node, and distributing the recomputed data rate assignments includes passing said assignments from the arbiter node to other nodes over the SONET ring.

16. The method of claim 12 wherein maintaining the assigned data rates for the communication channels includes determining a total amount of each of a series of frames passing on the SONET network that are available for the communication channels.

17. The method of claim 16 wherein determining a total amount of each of the series of frames includes determining an amount of each frame assigned to fixed-rate communication channels.

18. A communication system comprising:
a shared medium having a communication capacity;
a plurality of communication nodes coupled to the shared medium configured to pass data for a plurality of communication channels over the shared medium between the nodes; and
an arbiter coupled to the communication nodes and configured to maintain a data rate assignment for each of the communication channels such that a combination of the data rate assignments for the channels does not exceed the communication capacity if the shared medium and to communicate said data rate assignments to the communication nodes;
wherein each communication node is configured to accept data for one or more communication channels and to pass the data over the shared medium according to the data rate assignment for those communication channels, and is further configured to pass requests to change data rate assignments for the communication channels according to monitoring of communication on each of said communication channels;
wherein the arbiter is further configured to determine a share of the communication capacity for each of a plurality of priorities, maintain the data rate assignments according to the determined shares for each priority and requests to change data rate assignments passed from the communication nodes.

19. The communication system of claim 18 wherein the shared medium includes a SONET communication system, and the arbiter is configured to maintain an assignment of a portion of each SONET frame to each of the communication channels.
